(19) United States
(12) Patent Application Publication
(10) Pub. No.: US 2018/0138815 A1
(43) Pub. Date: May 17, 2018

(54) VOLTAGE CONVERTING DEVICE

(71) Applicants: Takashi Yamada, Gifu (JP); Yasumichi Omoto, Aichi (JP)

(72) Inventors: Takashi Yamada, Gifu (JP); Yasumichi Omoto, Aichi (JP)

(73) Assignee: OMRON AUTOMOTIVE ELECTRONICS CO., LTD., Aichi (JP)

(21) Appl. No.: 15/812,056

(22) Filed: Nov. 14, 2017

(30) Foreign Application Priority Data
Nov. 15, 2016 (JP) 2016-222188

(51) Int. Cl. H02M 3/158; G05F 3/08; G05F 1/565; H02M 3/07; H02M 3/28; H02M 1/32

(52) U.S. Cl. CPC H02M 3/1584; G05F 3/08; G05F 1/565; H02M 3/07; H02M 2001/0074; H02M 1/32; H02M 3/158; H02M 2003/072; H02M 3/285

(57) ABSTRACT

A voltage converting device is provided between a DC power supply and a load and includes parallelly-connected first and second voltage converting circuits and a control unit. The second voltage converting circuit has a rated output greater than that of the first voltage converting circuit. Under a condition where the load is a small load, the control unit operates only the first voltage converting circuit and stops an operation of the second voltage converting circuit. Under a condition where the load is a large load, the control unit operates both the first and second voltage converting circuits. In a process where the load is switched from the small load to the large load, the control unit stops the first voltage converting circuit and operates only the second voltage converting circuit, and then operates the first voltage converting circuit.

### CROSS-REFERENCES TO RELATED APPLICATIONS

This application is based upon and claims the benefit of priority from Japanese Patent Application No. 2016-222188, filed on Nov. 15, 2016, the entire contents of which are incorporated herein by reference.

### FIELD

One or more embodiments of the present invention relate to a voltage converting device such as a DC-DC converter, and, particularly, the voltage converting device including two voltage converting circuits which are switched according to a state of a load.

### BACKGROUND

For example, a DC-DC converter for converting a voltage of a battery (DC power supply) into a predetermined voltage and for supplying the predetermined voltage to a load such as an on-board equipment is mounted in a vehicle. A state of the load is changed according to an operating condition of the equipment, and when power consumption is small, the load is in a small load state, and when the power consumption is large, the load is in a large load state. In a case of the vehicle, since the load fluctuates frequently, the voltage converting device is required to have a capability of efficiently converting the voltage over a wide range from a small load to a large load. As a countermeasure against this, voltage converting devices in which a voltage converting circuit for a large load and a voltage converting circuit for a small load are connected in parallel are described in JP-A-2012-244862, JP-A-2001-204137, JP-A-2004-62331, JP-A-2009-60747 and JP-A-2012-10434.

In JP-A-2012-244862, a first converter unit and a second converter unit having different rated powers are connected in parallel such that only the first converter unit is driven in a first output power region and only the second converter unit is driven in a second output power region, and the first and the second converter units are driven in a third output power region.

In JP-A-2001-204137, a small capacity DC-DC converter and a large capacity DC-DC converter are connected in parallel, and when a required supply power of load is large, the large capacity DC-DC converter is driven by a switching control device, and when the required supply power of load is small, the large capacity DC-DC converter is paused such that the small capacity DC-DC converter is driven.

In JP-A-2004-62331, a first power source circuit having high efficiency at the time of supplying power source to a small load and a second power source circuit having high efficiency at the time of supplying the power source to a large load are connected in parallel, and the first power source circuit detects an output voltage of the second power source circuit such that whether or not a voltage is output to an output terminal is controlled.

In JP-A-2009-60747, a main power converter configured with a half bridge converter and an auxiliary power converter configured with a full bridge converter are connected in parallel, most of the power is supplied from the main power converter to the load, and in the remaining power, an output voltage to the load is adjusted by a switching operation of a switching element of the auxiliary power converter.

In JP-A-2012-10434, a first converter for a normal operation and a second converter for a small load operation are connected in parallel, the first converter is paused without pausing the second converter at the time of switching from the normal operation to the small load operation, and the output of power is restarted by the first converter at the time of switching from the small load operation to the normal operation.

However, characteristics of power conversion efficiency of the voltage converting circuit for the large load and the voltage converting circuit for the small load are different from each other. In the voltage converting circuit for the large load, conversion efficiency is high in a region in which output power is large, but the conversion efficiency is low in a region in which the output power is small. Meanwhile, in the voltage converting circuit for the small load, the conversion efficiency is high in a region in which the output power is small, but it is not possible to output large power. Here, for example, as described in JP-A-2012-244862, in a case where the output power of the voltage converting device is changed according to the fluctuation of load, by switching an operation to the voltage converting circuit having the highest efficiency, it is possible to maintain high conversion efficiency over a wide range from the small load to the large load.

### SUMMARY

One or more embodiments of the invention is to provide a voltage converting device having power conversion efficiency higher than that of the related art over a wide range from a small load to a large load.

According to one or more embodiments of the invention, there is provided a voltage converting device provided between a DC power supply and a load, the voltage converting device including: a first voltage converting circuit that converts a voltage of the DC power supply into a voltage of a predetermined level; a second voltage converting circuit that converts a voltage of the DC power supply into the voltage of a predetermined level; and a control unit that controls operations of the first voltage converting circuit and the second voltage converting circuit. The first voltage converting circuit and the second voltage converting circuit are connected in parallel, and a rated output of the second voltage converting circuit is greater than a rated output of the first voltage converting circuit. Under a condition where the load is a small load of which capacity is less than a fixed capacity, the control unit operates only the first voltage converting circuit and stops an operation of the second voltage converting circuit. Under a condition where the load is a large load of which capacity is equal to or greater than a fixed capacity, the control unit operates both the first voltage converting circuit and the second voltage converting circuit. In a process where the load is switched from the small load to the large load, the control unit stops the first voltage converting circuit and operates only the second voltage converting circuit, and then operates the first voltage converting circuit.

In a case where the load is switched from the small load to the large load, a fixed time is required for output power of the voltage converting device to increase to power for the large load, and there is a medium load state in the meantime. For this reason, when the first voltage converting circuit is operated in a process of increasing the output power, since the power conversion efficiency of the first voltage converting circuit for the small load decreases in the medium load, the power conversion efficiency of the voltage converting device also decreases. However, in a process where a load is switched from the small load to the large load, the first voltage converting circuit with low efficiency is stopped at the time of the medium load, and only the second voltage converting circuit with high efficiency is operated at the time of the medium load and thus it is possible to maintain the power conversion efficiency of the voltage converting device high, and it is possible to further efficiently convert the voltage more than the related art.

In one or more embodiments of the invention, in a process where the load is switched from the small load to a medium load of which capacity is greater than that of the small load and is smaller than that of the large load, the control unit may operate both the first voltage converting circuit and the second voltage converting circuit, and then stop the first voltage converting circuit.

In one or more embodiments of the invention, in a process where the load is switched from the large load to the small load, the first voltage converting circuit may be stopped and only the second voltage converting circuit is operated, and then the second voltage converting circuit may be stopped and the first voltage converting circuit may be operated.

In one or more embodiments of the invention, the first voltage converting circuit may be an LLC type converter including: a transformer; two switching elements that are provided on a primary side of the transformer and are connected in series to the DC power supply; a series circuit of a capacitor and an inductor connected between a connection point of the switching elements and a primary winding of the transformer; and a rectifying element that is provided on a secondary side of the transformer.

In one or more embodiments of the invention, the first voltage converting circuit may be a flyback type converter including: a transformer; a switching element that is provided on the primary side of the transformer and is connected in series to the primary winding of the transformer; and a rectifying element that is provided on a secondary side of the transformer.

In one or more embodiments of the invention, the second voltage converting circuit may be a full bridge converter including; a transformer; four switching elements that are provided on the primary side of the transformer and are bridge-connected between the DC power supply and the primary winding of the transformer; and a rectifying element that is provided on the secondary side of the transformer.

In one or more embodiments of the invention, the second voltage converting circuit may be a half bridge converter including: a transformer; two switching elements that are provided on the primary side of the transformer and are connected in series to the DC power supply; and a rectifying element that is provided on the secondary side of the transformer.

According to one or more embodiments of the invention, it is possible to provide a voltage converting device having power conversion efficiency higher than that of the related art over a wide range from a small load to a large load.

### BRIEF DESCRIPTION OF THE DRAWINGS

FIG. 1 is a block diagram of a voltage converting device according to one or more embodiments of the invention;

FIG. 2 is a diagram illustrating a circuit configuration of a first embodiment;

FIG. 3 is a diagram for explaining an operation at the time of a small load of the first embodiment;

FIG. 4 is a diagram for explaining an operation at the time of a medium load of the first embodiment;

FIG. 5 is a diagram for explaining an operation at the time of a large load of the first embodiment;

FIG. 6 a diagram for explaining an operation in a case where the load is switched from the small load to the large load of the first embodiment;

FIG. 7 a diagram for explaining an operation in a case where the load is switched from the large load to the small load of the first embodiment;

FIG. 8 is a diagram for explaining an operation at the time of switching from the small load to the medium load of the first embodiment;

FIG. 9 is a diagram illustrating a circuit configuration of a second embodiment;

FIG. 10 is a diagram for explaining an operation at the time of a small load of the second embodiment;

FIG. 11 is a diagram for explaining an operation at the time of a medium load of the second embodiment;

FIG. 12 is a diagram for explaining an operation at the time of a large load of the second embodiment;

FIG. 13 is a diagram for explaining an operation at the time of switching from the small load to the large load of the second embodiment;

FIG. 14 is a diagram for explaining an operation at the time of switching from the large load to the small load of the second embodiment; and

FIG. 15 is a diagram for explaining an operation at the time of switching from the small load to the medium load of the second embodiment.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

A voltage converting device according to one or more embodiments of the invention will be described with reference to the drawings. In each diagram, the same or corresponding parts are denoted by the same reference numerals.

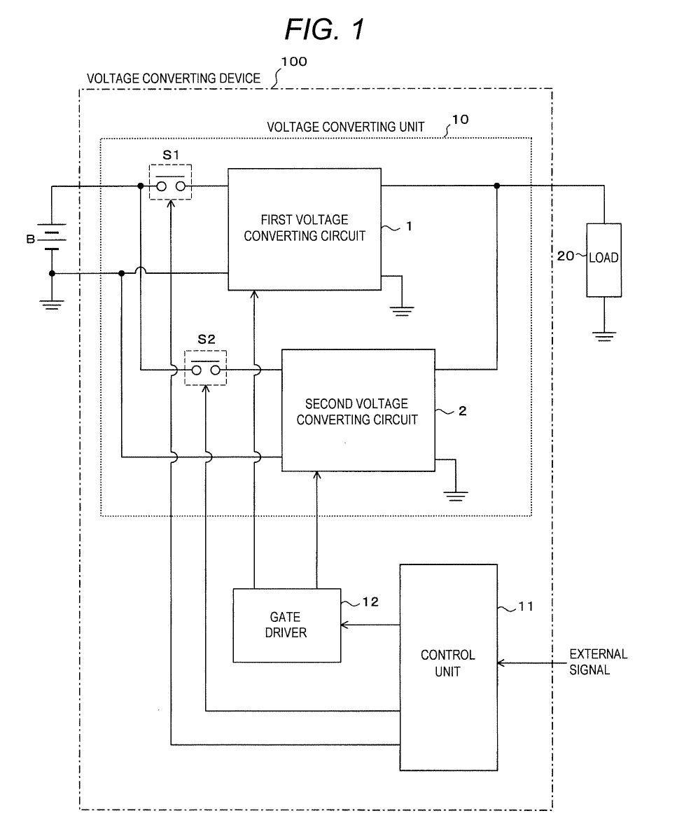

First, an overall configuration of a voltage converting device will be described with reference to FIG. 1. In FIG. 1, a voltage converting device 100 is provided between a DC power supply B and a load 20. A voltage converting unit 10, a control unit 11, and a gate driver 12 are provided in the voltage converting device 100. For example, the voltage converting device 100 is mounted in a vehicle, and used as a DC-DC converter that boosts a voltage of a DC power supply (battery) B and supplies the boosted voltage to the load 20. The load 20 includes various loads of on-board equipments such as head lights, air conditioners, audio devices, and car navigation devices, electric steering devices, power window devices, and the like.

The voltage converting unit 10 includes a first voltage converting circuit 1, a second voltage converting circuit 2, a switch S1, and a switch S2. The first voltage converting circuit 1 and the second voltage converting circuit 2 are connected in parallel between the DC power supply B and the load 20. Each of the voltage converting circuits 1 and 2 converts a voltage of the DC power supply B into a voltage of a predetermined level. The rated output (maximum output power can be safely achieved under specified condition) of the second voltage converting circuit 2 is larger than the rated output of the first voltage conversion circuit 1. A specific configuration of the voltage converting circuit 1 and 2 will be described below in detail. The switch S1 is provided between a positive electrode of the DC power supply B and the first voltage converting circuit 1. The switch S2 is provided between the positive electrode of the DC power supply B and the second voltage converting circuit 2. A negative electrode of the DC power supply B is grounded to the ground.

The control unit 11 is configured with a CPU, a memory, and the like. The control unit 11 provides a control signal for controlling an operation of the gate driver 12 to the gate driver 12, and provides control signals for controlling operations of the switches S1 and S2 to the switches S1 and S2. An external signal from an ECU (electronic control device) or the like which is mounted in the vehicle is input to the control unit 11. The control unit 11 performs a predetermined control operation based on the external signal.

The gate driver 12 is operated by the control signal from the control unit 11, and outputs a gate signal for turning on and off a plurality of switching elements (which will be described below) included in the first voltage converting circuit 1 and the second voltage converting circuit 2. For example, the gate signal is a pulse width modulation signal (PWM) having a predetermined duty, and provided to a gate of each of switching elements.

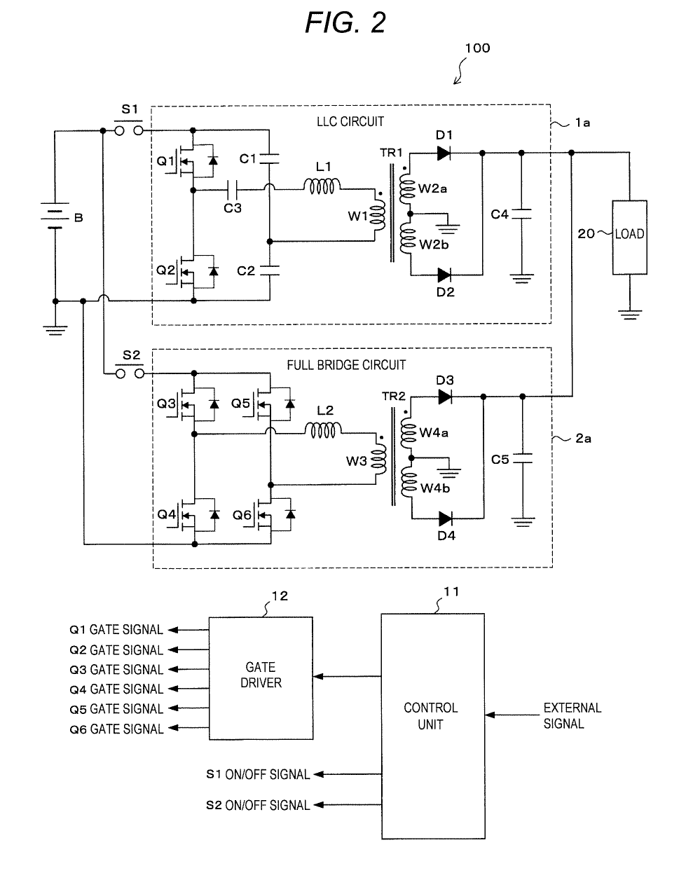

FIG. 2 is a specific circuit configuration of the voltage converting device 100 according to the first embodiment. In the present embodiment, the first voltage converting circuit 1 is configured with an LLC type converter (hereinafter, referred to as “LLC circuit”) 1a, and the second voltage converting circuit 2 is configured with a full bridge converter (hereinafter, referred to as “full bridge circuit”) 2a.

First, the LLC circuit 1a will be described. The LLC circuit 1a includes a transformer TR1 that insulates an input side and an output side. Two switching elements Q1 and Q2 connected in series to the DC power supply B, a series circuit of a capacitor C3 and an inductor L1 which is connected between a connection point of the switching elements Q1 and Q2 and a primary winding W1 of the transformer TR1, and a series circuit of the capacitors C1 and C2 connected in parallel with the series circuit of the switching elements Q1 and Q2 are provided on a primary side of the transformer TR1. Diodes D1 and D2 for rectifying and a capacitor C4 for smoothing are provided on a secondary side of the transformer TR1. The primary side of the transformer TR1 is a circuit that converts a DC voltage of the DC power supply B into an AC voltage through switching, and the secondary side of the transformer TR1 converts the AC voltage into the DC voltage through rectifying and smoothing.

The switching elements Q1 and Q2 are configured with MOS type field effect transistors (FETs), and include a parasitic diode connected in parallel with an electric path between a drain and a source. A drain of the switching element Q1 is connected to the positive electrode of the DC power supply B through the switch S1. A source of the switching element Q1 is connected to a drain of the switching element Q2. A source of the switching element Q2 is grounded to the ground. Each gate of the switching elements Q1 and Q2 is connected to the gate driver 12.

One end of the capacitor C3 is connected to the connection point of the switching elements Q1 and Q2, and the other end thereof is connected to one end of an inductor L1. The other end of the inductor L1 is connected to one end of the primary winding W1 of the transformer TR1. The other end of the primary winding W1 is connected to a connection point of capacitors C1 and C2. The capacitor C3 and the inductor L1 configure a series resonance circuit.

A secondary winding of the transformer TR1 is configured with a winding W2a and a winding W2b. A connection point (intermediate tap) between the windings is grounded to the ground. An anode of a diode D1 is connected to the winding W2a, and an anode of a diode D2 is connected to the winding W2b. A cathode of the diode D1 is connected to a cathode of the diode D2, and connected to one end of a capacitor C4. The one end of the capacitor C4 is connected to the load 20. The other end of the capacitor C4 is grounded to the ground. The diodes D1 and D2 are examples of a “rectifying element” in one or more embodiments of the invention.

Next, a full bridge circuit 2a will be described. The full bridge circuit 2a includes a transformer TR2 that insulates the input side and the output side. Four switching elements Q3 to Q6 bridge-connected between the DC power supply B and a primary winding W3 of the transformer TR2, and an inductor L2 connected between a connection point of the switching elements Q3 and Q4 and the primary winding W3 are provided on a primary side of the transformer TR2. Diodes D3 and D4 for rectifying and a capacitor C5 for smoothing are provided on a secondary side of the transformer TR2. The primary side of the transformer TR2 is a circuit that converts the DC voltage of the DC power supply B into the AC voltage through switching, and the secondary side of the transformer TR2 is a circuit that converts the AC voltage into the DC voltage through rectifying and smoothing.

The switching elements Q3 to Q6 are configured with MOS type field effect transistors and include a parasitic diode connected in parallel with an electric path between a drain and a source. Drains of the switching element Q3 and Q5 are connected to the positive electrode of the DC power supply B through the switch S2. Sources of the switching element Q3 and Q5 are connected to drains of the switching element Q4 and Q6, respectively. Sources of the switching element Q4 and Q6 are grounded to the ground. Each gate of the switching elements Q3 to Q6 is connected to the gate driver 12.

One end of the inductor L2 is connected to a connection point of the switching elements Q3 and Q4, and the other end thereof is connected to one end of the primary winding W3. The other end of the primary winding W3 is connected to a connection point of the switching elements Q5 and Q6.

A secondary winding of the transformer TR2 is configured with a winding W4a and a winding W4b. A connection point (intermediate tap) between the windings is grounded to the ground. An anode of a diode D3 is connected to the winding W4a, and an anode of a diode D4 is connected to the winding W4b. A cathode of the diode D3 is connected to a cathode of the diode D4, and connected to one end of a capacitor C5. The one end of the capacitor C5 is connected to the load 20. The other end of the capacitor C5 is grounded to the ground. The diodes D3 and D4 are examples of the “rectifying element” in one or more embodiments of the invention.

The gate driver 12 outputs a Q1 gate signal and a Q2 gate signal to gates of the switching elements Q1 and Q2 of the LLC circuit 1a, respectively. In addition, the gate driver 12 outputs Q3 to Q6 gate signals to gates of the switching elements Q3 to Q6 of the full bridge circuit 2a, respectively. Each of the switching elements Q1 to Q6 is in a turn-on state in a section in which these gate signals are high levels (H), and each of the switching elements Q1 to Q6 is in a turn-off state in a section in which these gate signals are low levels (L).

For example, the switches S1 and S2 are configured with relays. An operation of the switch S1 is controlled by an S1 on or off signal output from the control unit 11. In a case of the S1 on signal, the switch S1 is turned on, and in a case of the S1 off signal, the switch S1 is turned off. Similarly, an operation of the switch S2 is controlled by an S2 on or off signal output from the control unit 11. In a case of the S2 on signal, the switch S2 is turned on, and in a case of the S2 off signal, the switch S2 is turned off.

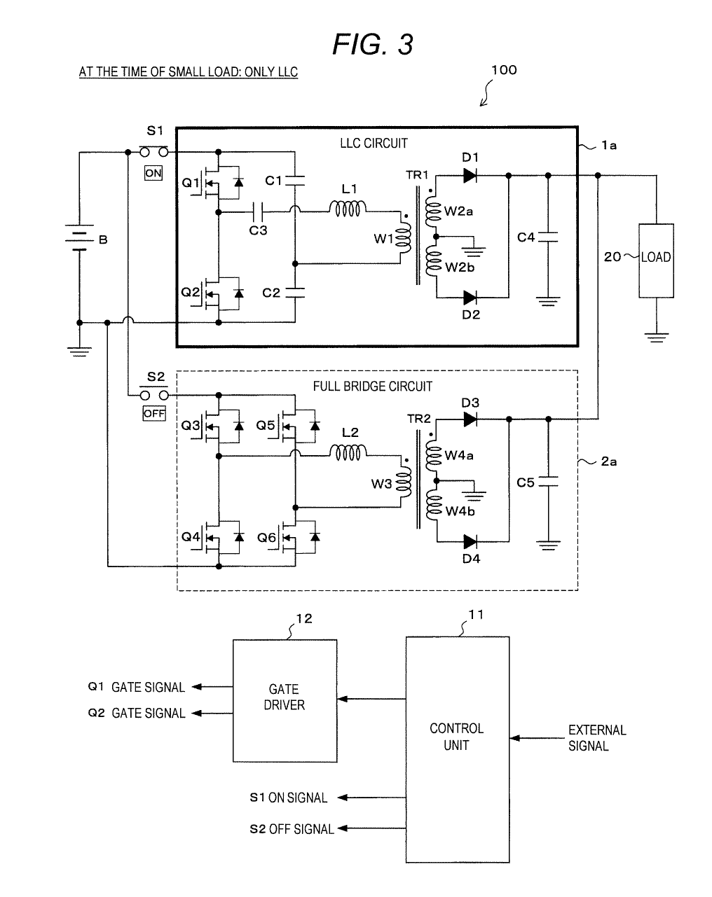

Next, an operation of the voltage converting device 100 of the first embodiment described above will be described with reference to FIG. 3 to FIG. 8.

FIG. 3 illustrates a circuit state of the voltage converting device 100 under a condition that the load 20 is a small load of which capacity is less than a fixed capacity. In this case, the control unit 11 determines that the load 20 is the small load based on an external signal input from an ECU or the like, and outputs the S1 on signal and the S2 off signal. With this, the switch S1 is turned on, the switch S2 is turned off, the LLC circuit 1a that is the first voltage converting circuit is connected to the DC power supply B, and the full bridge circuit 2a that is the second voltage converting circuit is disconnected from the DC power supply B. The gate driver 12 outputs the Q1 gate signal and the Q2 gate signal to gates of the switching elements Q1 and Q2 of the LLC circuit 1a, respectively, based on a control signal from the control unit 11, and the switching elements Q1 and Q2 are turned on or off by these gate signals.

An operation of the LLC circuit 1a is approximately as follows. In a section in which the switching element Q1 is turned on and the switching element Q2 is turned off, in the primary side of the transformer TR1, a current (resonance current) flows along a path of the DC power supply B→the switch S1→the switching element Q1→the capacitor C3→the inductor L1→the primary winding W1→a capacitor C2. By this current, in the secondary side of the transformer TR1, a current flows from a secondary winding W2a to the load 20 through a rectifying and smoothing circuit configured with the diode D1 and the capacitor C4.

Meanwhile, in a section in which the switching element Q1 is turned off and the switching element Q2 is turned on, in the primary side of the transformer TR1, a current (resonance current) flows along a path of the DC power supply B→the switch S1→a capacitor C1→the primary winding W1→the inductor L1→the capacitor C3→the switching element Q2. By this current, in the secondary side of the transformer TR1, a current flows from a secondary winding W2b to the load 20 through a rectifying and smoothing circuit configured with the diode D2 and the capacitor C4.

As described above, in a case where the load 20 is the small load, only the LLC circuit 1a is in an operation state, and the full bridge circuit 2a is in a stopped state. Therefore, output power of the voltage converting device 100 becomes output power of the LLC circuit 1a. The control unit 11 adjusts the duty of a gate signal for driving the switching elements Q1 and Q2 such that the output power of the voltage converting device 100 is controlled.

However, the LLC circuit 1a is designed to have power corresponding to the small load as the rated output to be the highest power conversion efficiency. Specifically, in the vicinity of the rated output of the LLC circuit 1a, the switching elements Q1 and Q2 perform a zero-voltage switching (ZVS) operation. As well known, the ZVS is a driving operation that suppresses switching loss by turning on the switching element in a state where a terminal voltage of the switching element is zero. As the switching loss is reduced by the ZVS, the power conversion efficiency is improved. Meanwhile, in a case where a circuit design is performed to satisfy the ZVS at the time of the small load, the ZVS is not satisfied when the load increases, and the power conversion efficiency decreases.

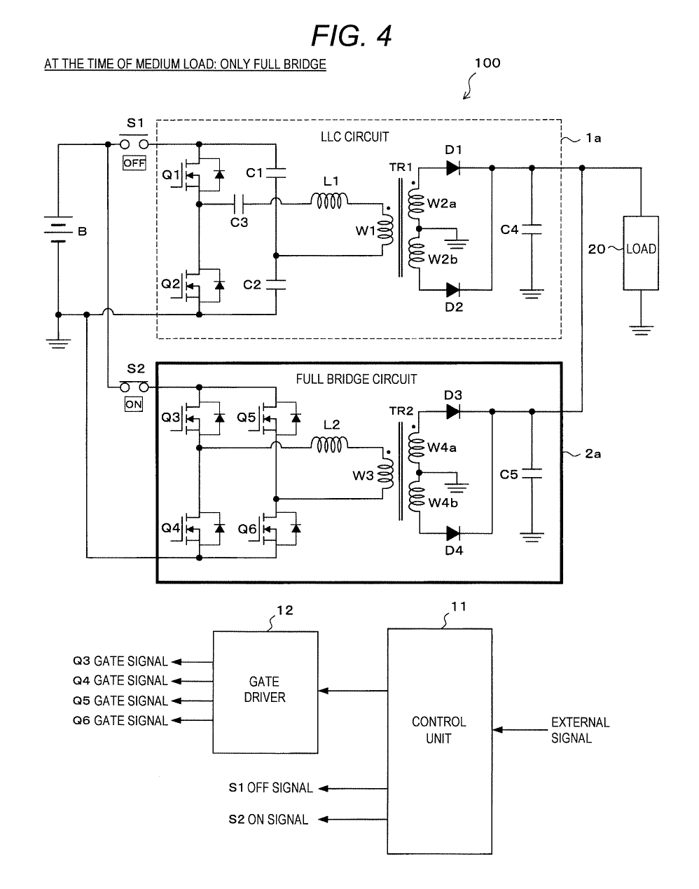

FIG. 4 illustrates a circuit state of the voltage converting device 100 under a condition where the load 20 is the medium load of which capacity is larger than the small load and is smaller than the large load. In this case, the control unit 11 determines that the load 20 is the medium load based on the external signal input from the ECU or the like, and outputs the S1 off signal and the S2 on signal. With this, the switch S1 is turned off, the switch S2 is turned on, the full bridge circuit 2a that is the second voltage converting circuit is connected to the DC power supply B, and the LLC circuit 1a that is the first voltage converting circuit is disconnected from the DC power supply B. The gate driver 12 outputs Q3 to Q6 gate signals to gates of the switching elements Q3 to Q6 of the full bridge circuit 2a, respectively, based on a control signal from the control unit 11, and the switching elements Q3 to Q6 are turned on or off by these gate signals.

An operation of the full bridge circuit 2a is approximately as follows. In a section in which the switching elements Q3 and Q6 are turned on and the switching elements Q4 and Q5 are turned off, in the primary side of the transformer TR2, a current flows along a path of the DC power supply B→the switch S2→the switching element Q3→the inductor L2→the primary winding W3→the switching element Q6. By this current, in the secondary side of the transformer TR2, a current flows from a secondary winding W4a to the load 20 through a rectifying and smoothing circuit configured with the diode D3 and the capacitor C5.

Meanwhile, in a section in which the switching elements Q3 and Q6 are turned off and the switching elements Q4 and Q5 are turned on, in the primary side of the transformer TR2, a current flows along a path of the DC power supply B→the switch S2→the switching element Q5→the primary winding W3→the inductor L2→the switching element Q4. With this current, in the secondary side of the transformer TR2, a current flows from the secondary winding W4b to the load 20 through a rectifying and smoothing circuit configured with the diode D4 and the capacitor C5.

As described above, in a case where the load 20 is the medium load, only the full bridge circuit 2a is in an operation state, and the LLC circuit 1a is in the stopped state. Therefore, the output power of the voltage converting device 100 becomes output power of the full bridge circuit 2a. The control unit 11 adjusts the duty of a gate signal for driving the switching elements Q3 to Q6 such that the output power of the voltage converting device 100 is controlled.

However, the full bridge circuit 2a is designed to have power corresponding to the medium load as the rated output to be the highest power conversion efficiency. Specifically, in the vicinity of the rated output of the full bridge circuit 2a, the switching elements Q3 to Q6 perform the above-described ZVS. As the switching loss is reduced by the ZVS, the power conversion efficiency is improved. Meanwhile, in a case where a circuit design is performed to satisfy the ZVS at the time of the medium load, the ZVS is not satisfied when the load is reduced, and the power conversion efficiency decreases.

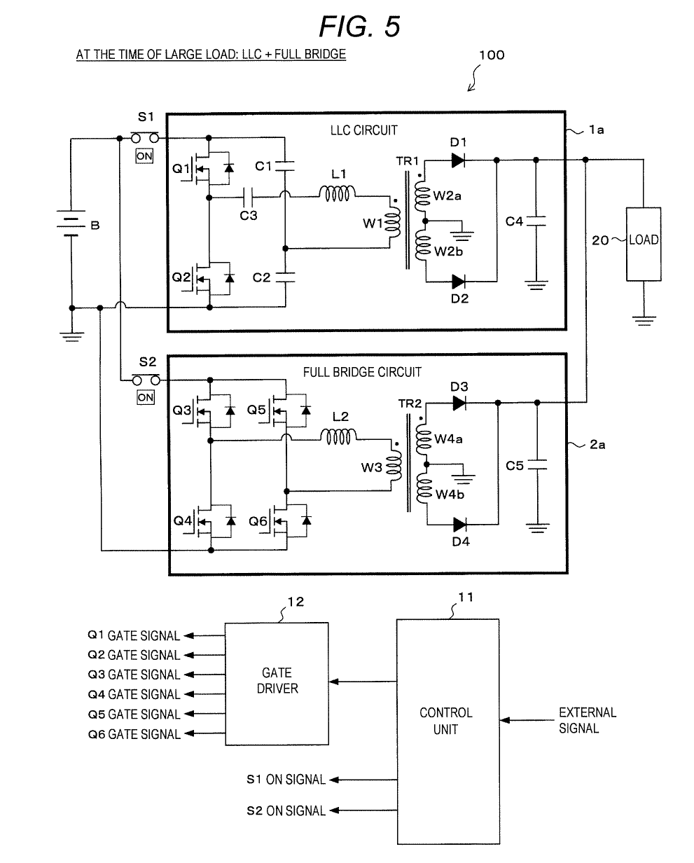

FIG. 5 illustrates a circuit state of the voltage converting device 100 under a condition where the load 20 is the large load of which capacity is equal to or greater than a fixed capacity. In this case, the control unit 11 determines that the load 20 is the large load based on the external signal input from the ECU or the like, and outputs the S1 on signal and the S2 on signal. With this, the switches S1 and S2 are turned on, the LLC circuit 1a that is the first voltage converting circuit and the full bridge circuit 2a that is the second voltage converting circuit are connected to the DC power supply B. Therefore, the gate driver 12 outputs the Q1 gate signal and the Q2 gate signal to gates of the switching elements Q1 to Q2 of the LLC circuit 1a, and outputs Q3 to Q6 gate signals to gates of the switching elements Q3 to Q6 of the full bridge circuit 2a, respectively, based on a control signal from the control unit 11. The switching elements Q1 to Q6 are turned on or off by these gate signals.

As described above, in a case where the load 20 is the large load, both the LLC circuit 1a and the full bridge circuit 2a are in the operation state. Therefore, the output power of the voltage converting device 100 becomes power obtained by adding output power of the LLC circuit 1a and output power of the full bridge circuit 2a. The control unit 11 adjusts the duty of a gate signal for driving the switching elements Q1 to Q6 such that the output power of the voltage converting device 100 is controlled.

In this case, since the output power of the LLC circuit 1a and the output power of the full bridge circuit 2a are powers converted with high efficiency, the power conversion efficiency of the entire voltage converting device 100 is also maintained at a high value.

As described above, in a case where the load 20 is the small load, only the LLC circuit 1a is operated, in a case where the load 20 is the medium load, only the full bridge circuit 2a is operated, and in a case where the load 20 is the large load, both the LLC circuit 1a and the full bridge circuit 2a are operated, and thus it is possible to efficiently convert the voltage over a wide range from a small load to a large load.

However, since the load 20 fluctuates frequently according to a situation of the vehicle, it is desired to maintain the power conversion efficiency high not only in a steady state of each of the small load, the medium load, and the large load but also in a transient state in which the load fluctuates. From such a viewpoint, one or more embodiments of the invention are designed to further improve the efficiency of voltage conversion by improving the power conversion efficiency at the time of load fluctuation.

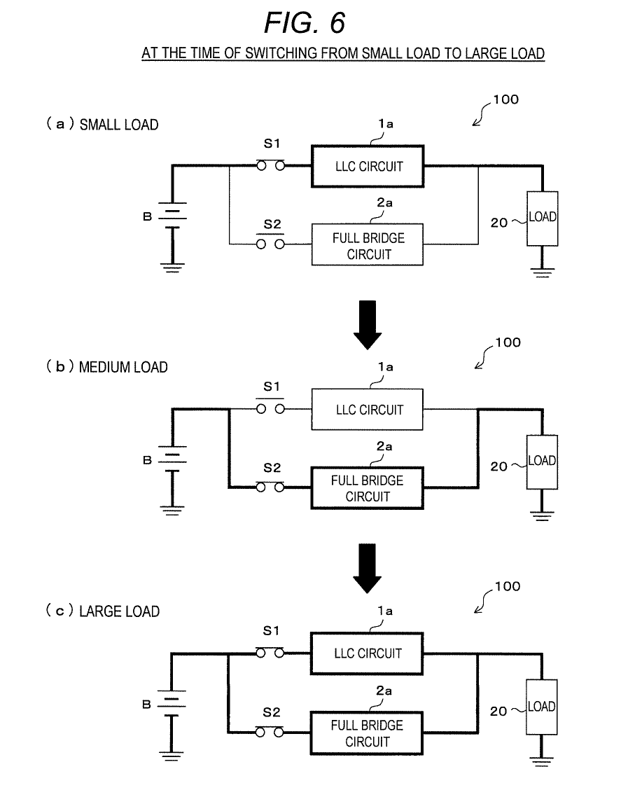

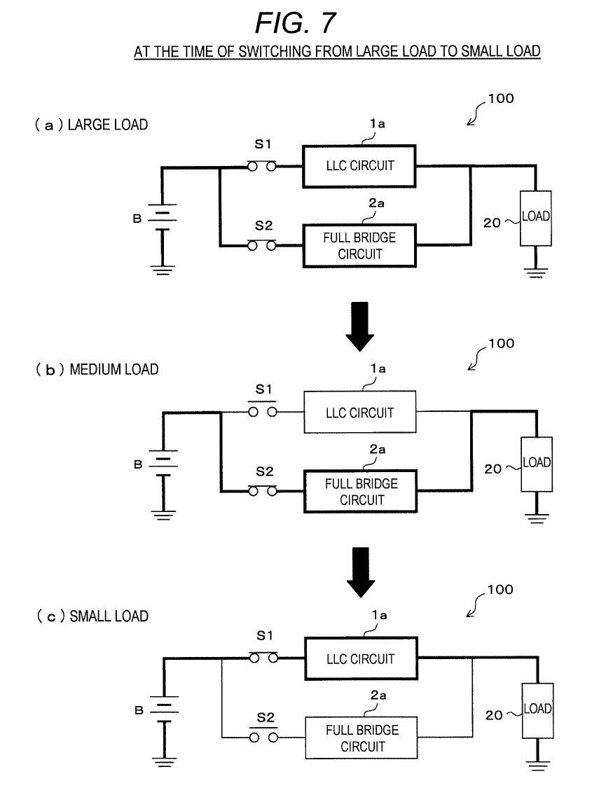

FIG. 6 and FIG. 7 are diagrams for explaining an operation at the time of load fluctuation according to one or more embodiments of the invention. FIG. 6 illustrates an operation of a case where the load 20 is switched from (a) the small load to (c) the large load. FIG. 7 illustrates an operation of a case where the load 20 is switched from (a) the large load to (c) the small load.

First, an operation at the time of switching from the small load to the large load will be described. FIG. 6 is a diagram obtained by simplifying FIG. 3 to FIG. 5. In the related art, in a case where the load 20 is the small load, as illustrated in (a) of FIG. 6, only the LLC circuit 1a is operated. In a case where the load 20 is switched from this state to the large load, as illustrated in (c) of FIG. 6, the full bridge circuit 2a is operated, and both circuits 1a and 2a are in the operation state. However, in one or more embodiments of the invention, in a process where the load 20 is switched from the small load to the large load, the LLC circuit 1a is stopped first and only the full bridge circuit 2a is operated (medium load state) as illustrated in (b) of FIG. 6. Then, as illustrated in (c) of FIG. 6, the LLC circuit 1a is operated, and both circuits 1a and 2a is in the operation state (large load state). That is, the feature of one or more embodiments of the invention is that a medium load state is passed in the middle of transitioning without suddenly transitioning from a small load state to a large load state.

In a case where the load 20 is switched from the small load to the large load, as illustrated in (c) of FIG. 6, even if both circuits of the LLC circuit 1a and the full bridge circuit 2a are operated, a fixed time is required for the output power of the voltage converting device 100 to increase to the power for the large load. That is, there is the medium load state in the meantime. For this reason, when the LLC circuit 1a is operated in the process of increasing the output power, since the power conversion efficiency of the LLC circuit 1a for the small load decreases in the medium load, the power conversion efficiency of the voltage converting device 100 also decreases.

However, in one or more embodiments of the invention, in the process of increasing the output power of the voltage converting device 100, as illustrated in (b) of FIG. 6, since the LLC circuit 1a having low efficiency at the time of the medium load is stopped and only the full bridge circuit 2a having high efficiency at the time of the medium load is operated, the power conversion efficiency of the voltage converting device 100 is maintained high. For this reason, in a case of switching from the small load to the large load, it is possible to improve the power conversion efficiency, and it is possible to further convert efficiently the voltage more than the related art.

Next, an operation at the time of switching from the large load to the small load will be described. FIG. 7 is a diagram obtained by simplifying FIG. 3 to FIG. 5. In a case where the load 20 is the large load, as illustrated in (a) of FIG. 7, both the LLC circuit 1a and the full bridge circuit 2a are operated. In the related art, in a case where the load 20 is switched from this state to the small load, as illustrated in (c) of FIG. 7, the full bridge circuit 2a is stopped, and only the LLC circuit 1a is in the operation state. However, in one or more embodiments of the invention, in a process where the load 20 is switched from the large load to the small load, the LLC circuit 1a is stopped first and only the full bridge circuit 2a is operated (medium load state) as illustrated in (b) of FIG. 7. Then, as illustrated in (c) of FIG. 7, the full bridge circuit 2a is stopped and the LLC circuit 1a is operated (small load state). That is, the feature of one or more embodiments of the invention is that a medium load state is passed in the middle of transitioning without suddenly transitioning from the large load state to the small load state.

In a case where the load 20 is switched from the large load to the small load, as illustrated in (c) of FIG. 7, even if the full bridge circuit 2a is stopped, a fixed time is required for the output power of the voltage converting device 100 to decrease to the power for the small load. That is, the medium load state is also present in this case. For this reason, when the LLC circuit 1a is operated in a process of decreasing the output power, since the power conversion efficiency of the LLC circuit 1a for the small load decreases in the medium load, the power conversion efficiency of the voltage converting device 100 also decreases.

However, in one or more embodiments of the invention, in the process of decreasing the output power of the voltage converting device 100, as illustrated in (b) of FIG. 7, since the LLC circuit 1a having low efficiency at the time of the medium load is stopped and only the full bridge circuit 2a having high efficiency at the time of the medium load is operated, the power conversion efficiency of the voltage converting device 100 is maintained high. For this reason, in a case of switching from the large load to the small load, it is possible to improve the power conversion efficiency, and it is possible to further convert efficiently the voltage more than the related art.

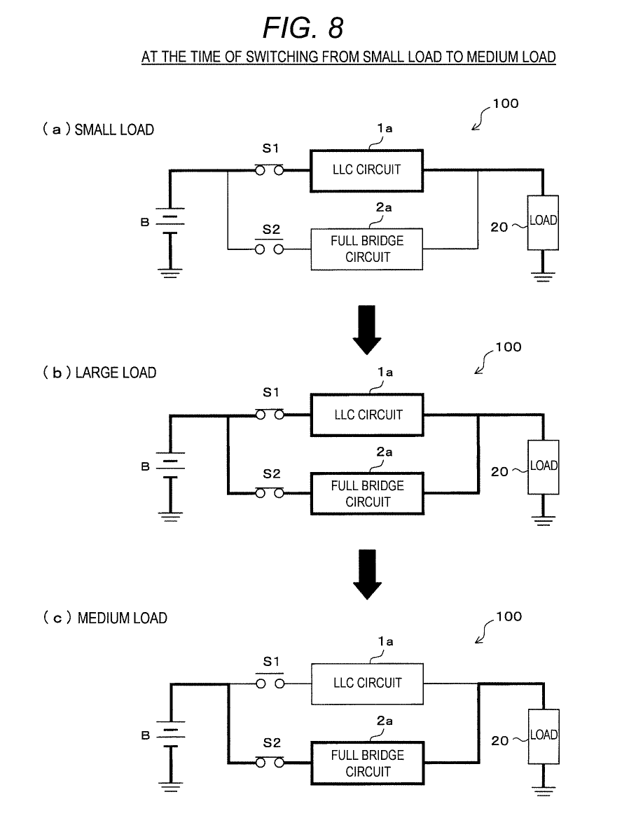

In FIG. 6, a case where the load 20 is changed from the small load to the large load is described, but in a case where the load 20 is changed from the small load to the medium load, a sequence of (a) to (b) of FIG. 6 is obtained. However, in this case, depending on the fluctuation state of the load 20, the output power of the voltage converting device 100 may be temporarily short. To avoid this, as illustrated in FIG. 8, the load state may be switched from the small load state of (a) of FIG. 8 to the large load state of (b) of FIG. 8 first, and then finally may be switched to the medium load state of (c) of FIG. 8 while monitoring the load state. In this manner, since the maximum output is secured at the time of switching the load 20, even when the load 20 fluctuates, it is possible to avoid insufficient output power of the voltage converting device 100.

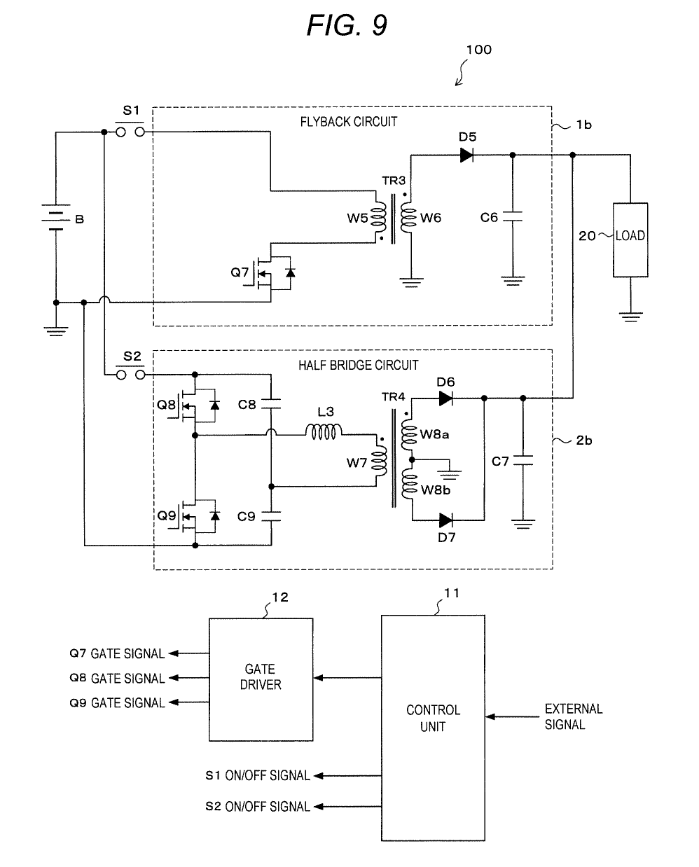

FIG. 9 illustrates a specific circuit configuration of the voltage converting device 100 according to a second embodiment. In the present embodiment, the first voltage converting circuit 1 is configured with a flyback type converter (hereinafter, referred to as “flyback circuit”) 1b, and the second voltage converting circuit 2 is configured with a half bridge converter (hereinafter, referred to as “half bridge circuit”) 2b.

First, the flyback circuit 1b will be described. The flyback circuit 1b includes a transformer TR3 that insulates the input side and the output side. A switching element Q7 connected in series to a primary winding W5 of the transformer TR3 is provided on a primary side of the transformer TR3. A diode D5 for rectifying and a capacitor C6 for smoothing are provided on a secondary side of the transformer TR3. The primary side of the transformer TR3 is a circuit that converts the DC voltage of the DC power supply B into the AC voltage through the switching, and the secondary side of the transformer TR3 is a circuit that converts the AC voltage into the DC voltage through the rectifying and smoothing.

The switching element Q7 is configured with a MOS type field effect transistor and includes a parasitic diode connected in parallel with an electric path between a drain and a source. A drain of the switching element Q7 is connected to one end of the primary winding W5 of the transformer TR3. The other end of the primary winding W5 is connected to a positive electrode of the DC power supply B through the switch S1. A source of the switching element Q7 is grounded to the ground. A gate of the switching element Q7 is connected to the gate driver 12.

An anode of the diode D5 is connected to one end of a secondary winding W6 of the transformer TR3. The other end of the secondary winding W6 is grounded to the ground. A cathode of the diode D5 is connected to one end of a capacitor C6. One end of the capacitor C6 is connected to the load 20. The other end of the capacitor C6 is grounded to the ground. The diode D5 is an example of the “rectifying element” in one or more embodiments of the invention.

Next, the half bridge circuit 2b will be described. The half bridge circuit 2b includes a transformer TR4 that insulates the input side and the output side. Two switching elements Q8 and Q9 connected in series to the DC power supply B, an inductor L3 connected between a connection point of the switching elements Q8 and Q9 and a primary winding W7 of the transformer TR4, and a series circuit of the capacitors C8 and C9 connected in parallel with a series circuit of the switching elements Q8 and Q9 are provided on a primary side of the transformer TR4. Diodes D6 and D7 for rectifying and a capacitor C7 for smoothing are provided on a secondary side of the transformer TR4. The primary side of the transformer TR4 is a circuit that converts the DC voltage of the DC power supply B into the AC voltage through the switching, and the secondary side of the transformer TR4 is a circuit that converts the AC voltage into the DC voltage through the rectifying and smoothing.

The switching elements Q8 and Q9 are configured with MOS type field effect transistors and include a parasitic diode connected in parallel with an electric path between a drain and a source. A drain of the switching element Q8 is connected to the positive electrode of the DC power supply B through the switch S2. A source of the switching element Q8 is connected to a drain of a switching element Q9. A source of the switching element Q9 is grounded to the ground. Each gate of the switching elements Q8 and Q9 is connected to the gate driver 12.

One end of the inductor L3 is connected to a connection point of the switching elements Q8 and Q9, and the other end thereof is connected to one end of the primary winding W7. The other end of the primary winding W7 is connected to a connection point of the capacitors C8 and C9.

A secondary winding of the transformer TR4 is configured with a winding W8a and a winding W8b. A connection point (intermediate tap) between these windings is grounded to the ground. An anode of a diode D6 is connected to the winding W8a, and an anode of a diode D7 is connected to the winding W8b. A cathode of the diode D6 is connected to a cathode of the diode D7, and connected to one end of a capacitor C7. The one end of the capacitor C7 is connected to the load 20. The other end of the capacitor C7 is grounded to the ground. The diodes D6 and D7 are examples of the “rectifying element” in one or more embodiments of the invention.

The gate driver 12 outputs a Q7 gate signal to the gate of the switching element Q7 of the flyback circuit 1b. In addition, the gate driver 12 outputs a Q8 gate signal and a Q9 gate signal to gates of the switching elements Q8 and Q9 of the half bridge circuit 2b, respectively. Each of the switching elements Q7 to Q9 is in the turn-on state in a section in which these gate signals are H, and each of the switching elements Q7 to Q9 is in the turn-off state in a section in which these gate signals are L.

The switches S1 and S2 and the control unit 11 are the same as those of the first embodiment (FIG. 2) such that the explanation will be omitted.

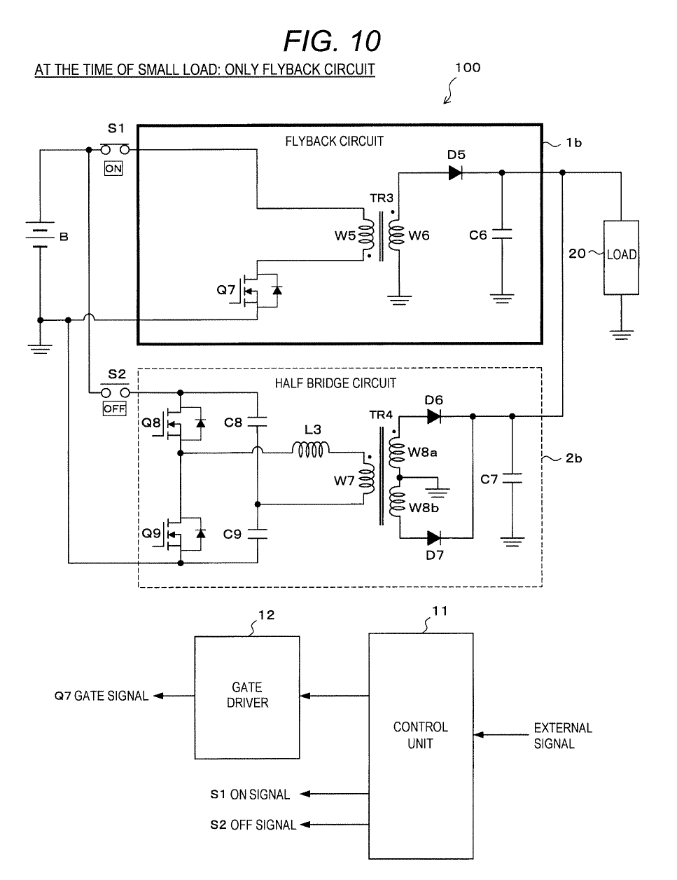

Next, an operation of the voltage converting device 100 of the second embodiment described above will be described with reference to FIG. 10 to FIG. 15.

FIG. 10 illustrates a circuit state of the voltage converting device 100 under a condition where the load 20 is the small load. In this case, the control unit 11 determines that the load 20 is the small load based on the external signal input from the ECU or the like, and outputs the S1 on signal and the S2 off signal. With this, the switch S1 is turned on, the switch S2 is turned off, the flyback circuit 1b that is the first voltage converting circuit is connected to the DC power supply B, and the half bridge circuit 2b that is the second voltage converting circuit is disconnected from the DC power supply B. Therefore, the gate driver 12 outputs the Q7 gate signal to the gate of the switching element Q7 of the flyback circuit 1b, based on a control signal from the control unit 11. The switching element Q7 is turned on or off by the gate signal.

An operation of the flyback circuit 1b is approximately as follows. In a section in which the switching elements Q7 is turned on, in the primary side of the transformer TR3, a current flows along a path of the DC power supply B→the switch S1→the primary winding W5→the switching element Q7, and electric energy is stored in the primary winding W5 (inductance). When the switching element Q7 is turned off, the electric energy stored in the primary winding W5 is released, the electric energy is transmitted to the secondary winding W6 such that, in the secondary side of the transformer TR3, a current flows from the secondary winding W6 to the load 20 through a rectifying and smoothing circuit configured with the diode D5 and the capacitor C6.

As described above, in a case where the load 20 is the small load, only the flyback circuit 1b is in the operation state, and the half bridge circuit 2b is in the stopped state. Therefore, the output power of the voltage converting device 100 becomes output power of the flyback circuit 1b. The control unit 11 adjusts the duty of a gate signal for driving the switching element Q7 such that the output power of the voltage converting device 100 is controlled. The flyback circuit 1b is designed to have power corresponding to the small load as the rated output so as to obtain the highest power conversion efficiency.

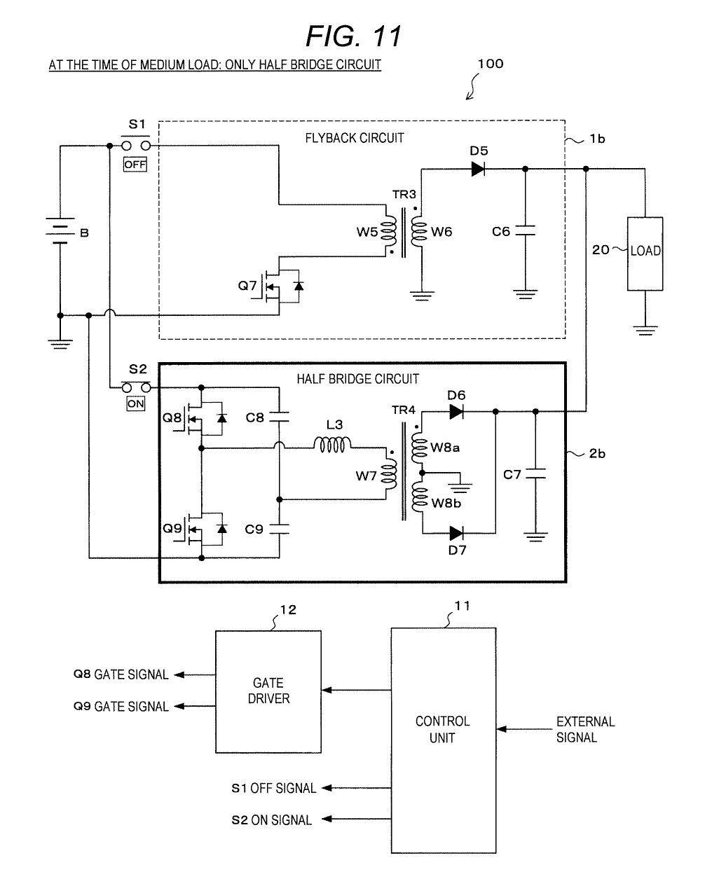

FIG. 11 illustrates a circuit state of the voltage converting device 100 under a condition where the load 20 is the medium load. In this case, the control unit 11 determines that the load 20 is the medium load based on the external signal input from the ECU or the like, and outputs the S1 off signal and the S2 on signal. With this, the switch S1 is turned off, the switch S2 is turned on, the half bridge circuit 2b that is the second voltage converting circuit is connected to the DC power supply B, and the flyback circuit 1b that is the first voltage converting circuit is disconnected from the DC power supply B. Therefore, the gate driver 12 outputs a Q8 gate signal and a Q9 gate signal to gates of the switching elements Q8 and Q9 of the half bridge circuit 2b, respectively, based on a control signal from the control unit 11. The switching elements Q8 and Q9 are turned on or off by these gate signals.

An operation of the half bridge circuit 2b is approximately as follows. In a section in which the switching elements Q8 is turned on and the switching elements Q9 is turned off, in the primary side of the transformer TR4, a current flows along a path of the DC power supply B→the switch S2→the switching element Q8→the inductor L3→the primary winding W7→a capacitor C9. By this current, in the secondary side of the transformer TR4, a current flows from a secondary winding W8a to the load 20 through a rectifying and smoothing circuit configured with the diode D6 and the capacitor C7.

Meanwhile, in a section where the switching element Q8 is turned off and the switching element Q9 is turned on, in the primary side of the transformer TR4, a current flows along a path of the DC power supply B→the switch S2→a capacitor C8→the primary winding W7→the inductor L3→the switching element Q9. By this current, in the secondary side of the transformer TR4, a current flows from a secondary winding W8b to the load 20 through a rectifying and smoothing circuit configured with the diode D7 and the capacitor C7.

As described above, in a case where the load 20 is the medium load, only the half bridge circuit 2b is in the operation state, and the flyback circuit 1b is in the stopped state. Therefore, the output power of the voltage converting device 100 becomes output power of the half bridge circuit 2b. The control unit 11 adjusts the duty of a gate signal for driving the switching elements Q8 and Q9 such that the output power of the voltage converting device 100 is controlled. The half bridge circuit 2b is designed to have power corresponding to the medium load as the rated output so as to obtain the highest power conversion efficiency.

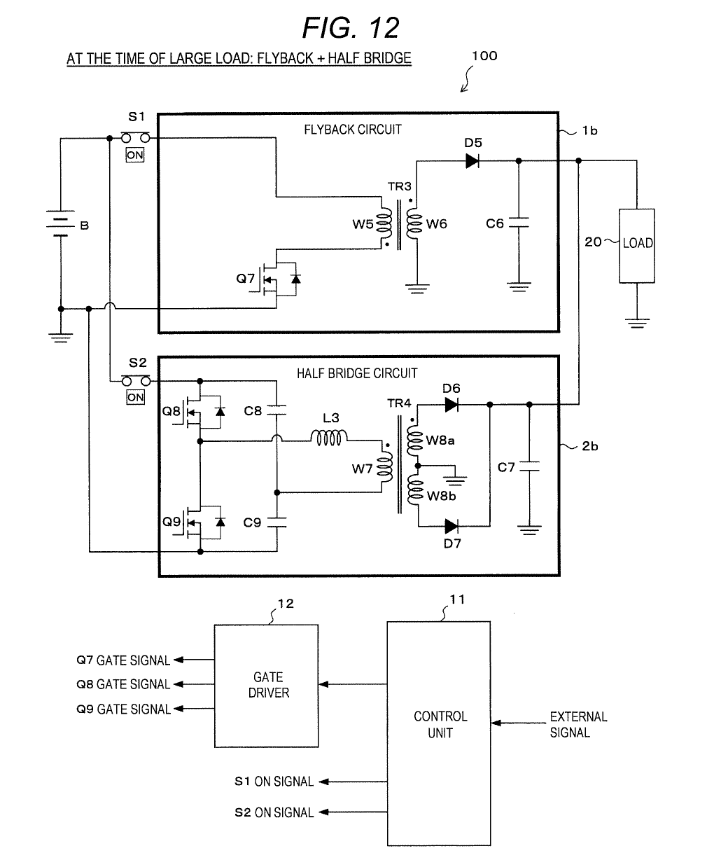

FIG. 12 illustrates a circuit state of the voltage converting device 100 under a condition where the load 20 is the large load. In this case, the control unit 11 determines that the load 20 is the large load based on the external signal input from the ECU or the like, and outputs the S1 on signal and the S2 on signal. With this, the switches S1 and S2 are turned on, the flyback circuit 1b that is the first voltage converting circuit and the half bridge circuit 2b that is the second voltage converting circuit are connected to the DC power supply B. Therefore, the gate driver 12 outputs the Q7 gate signal to the gate of the switching element Q7 of the flyback circuit 1b, and outputs the Q8 gate signal and the Q9 gate signal to the gates of the switching elements Q8 and Q9 of the half bridge circuit 2b, respectively, based on a control signal from the control unit 11. The switching elements Q7 to Q9 are turned on or off by these gate signals.

As described above, in a case where the load 20 is the large load, both the flyback circuit 1b and the half bridge circuit 2b are in the operation state. Therefore, the output power of the voltage converting device 100 becomes power obtained by adding output power of the flyback circuit 1b and output power of the half bridge circuit 2b. The control unit 11 adjusts the duty of a gate signal for driving the switching elements Q7 to Q9 such that the output power of the voltage converting device 100 is controlled.

In this case, since the output power of the flyback circuit 1b and the output power of the half bridge circuit 2b are powers converted with high efficiency, the power conversion efficiency of the entire voltage converting device 100 is also maintained at a high value.

As described above, in a case where the load 20 is the small load, only the flyback circuit 1b is operated, in a case where the load 20 is the medium load, only the half bridge circuit 2b is operated, and in a case where the load 20 is the large load, both the flyback circuit 1b and the half bridge circuit 2b are operated, and thus it is possible to efficiently convert the voltage over the wide range from the small load to the large load.

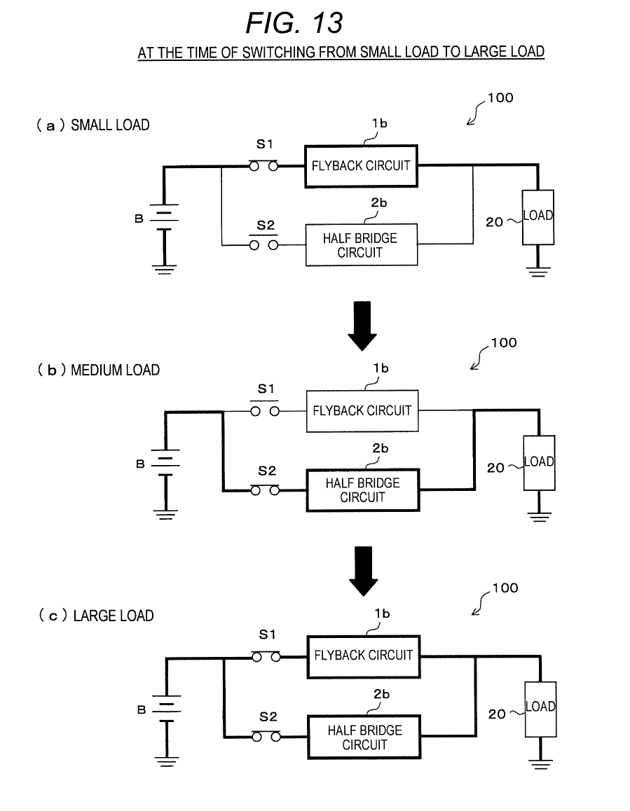

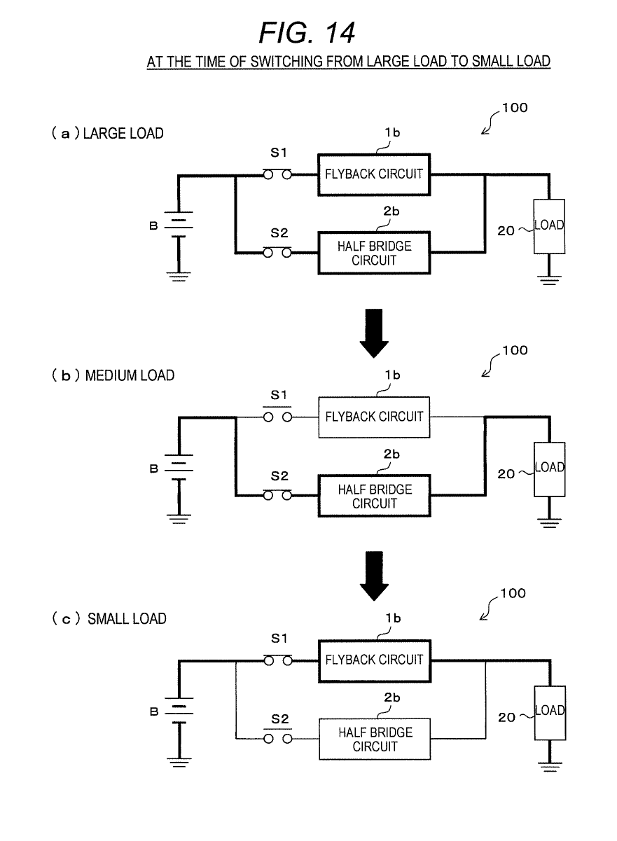

In addition, also in the second embodiment, similar to the first embodiment, a method for maintaining a high power conversion efficiency in a transient state of the load fluctuation is adopted. FIG. 13 illustrates an operation of a case where the load 20 is switched from the small load to the large load. FIG. 14 illustrates an operation of a case where the load 20 is switched from the large load to the small load. Since the sequences illustrated in these diagrams are basically the same as those of the case of the first embodiment (FIG. 6 and FIG. 7), and only a brief description will be given below.

At the time of switching from the small load to the large load, as illustrated in FIG. 13, from the small load state of (a) of FIG. 13, as illustrated in (b) of FIG. 13, the flyback circuit 1b is stopped first, and only the half bridge circuit 2b is operated (medium load state). Then, as illustrated in (c) of FIG. 13, the flyback circuit 1b is operated, and both circuits 1b and 2b are in the operation state (large load state). That is, the load state transitions from the small load state to the large load state via the medium load state.

At the time of switching from the large load to the small load, as illustrated in FIG. 14, from the large load state of (a) of FIG. 14, as illustrated in (b) of FIG. 14, the flyback circuit 1b is stopped first, and only the half bridge circuit 2b is operated (medium load state). Then, as illustrated in (c) of FIG. 14, the half bridge circuit 2b is stopped and the flyback circuit 1b is operated (small load state). That is, the load state transitions from the large load state to the small load state via the medium load state.

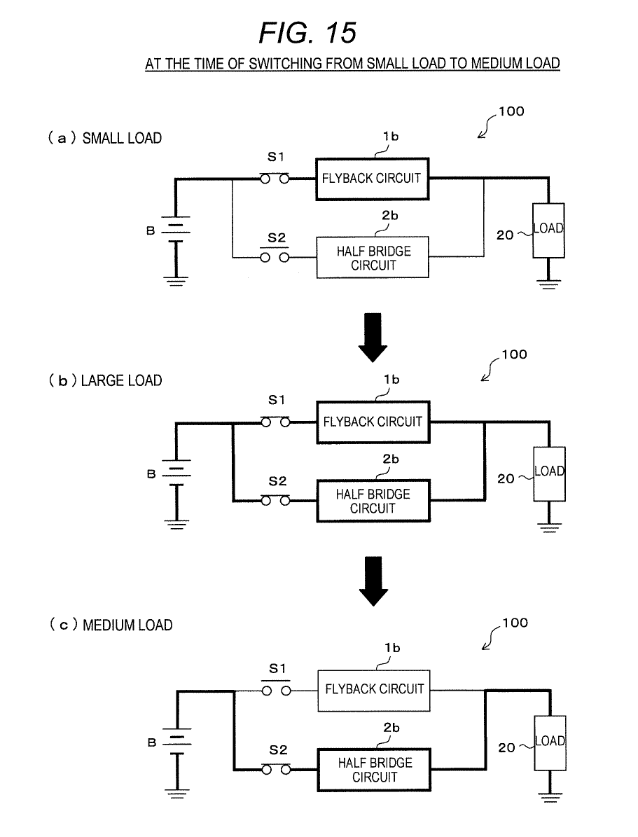

Also in the second embodiment, in a case where the load 20 is switched from the small load to the medium load, in the sequence of (a) to (b) of FIG. 13, depending on the fluctuation state of the load 20, the output power of the voltage converting device 100 may be temporarily short. To avoid this, similar to the case of the first embodiment, as illustrated in FIG. 15, the load state may be switched from the small load state of (a) of FIG. 15 to the large load state of (b) of FIG. 15 first, and then finally may be switched to the medium load state of (c) of FIG. 15 while monitoring the load state.

In the invention, in addition to the embodiments described above, various embodiments described below can be adopted.

In the first embodiment (FIG. 2), the LLC circuit 1a is adopted as the first voltage converting circuit. However, instead of the LLC circuit 1a, the flyback circuit 1b that is the first voltage converting circuit of the second embodiment (FIG. 9) may be adopted.

In the second embodiment (FIG. 9), the flyback circuit 1b is adopted as the first voltage converting circuit. However, instead of the flyback circuit 1b, the LLC circuit 1a that is the first voltage converting circuit of the first embodiment (FIG. 2) may be adopted.

In each embodiment, the control unit 11 determines the state of the load 20 based on the external signal supplied from the ECU or the like. However, instead of this, a detection unit for detecting the current, the voltage, or the power of the load 20 is provided, and thus the load state may be determined based on an output of the detection unit.

In each embodiment, the relays as the switches S1 and S2 provided between the DC power supply B and the voltage converting circuits 1 and 2 are exemplified. However, an FET, a transistor, or the like may be used instead of the relay. In addition, the switches S1 and S2 are omitted such that the voltage converting circuits 1 and 2 may be always connected to the DC power supply B. When the gate signal is supplied from the gate driver 12, an operation of the voltage converting circuits 1 and 2 may be activated.

In each embodiment, an insulated DC-DC converter in which the input side (primary side) and the output side (secondary side) are insulated by the transformers TR1 to TR4 is exemplified. However, the presence invention can also be applied to a non-insulated DC-DC converter.

In each embodiment, the voltage converting device 100 is the DC-DC converter. However, the voltage converting device of one or more embodiments of the invention may be a DC-AC converter. In this case, a voltage converting circuit for switching the DC voltage obtained on the secondary side of the transformers TR1 to TR4 into the AC voltage is added.

In each embodiment, the FET is used as the switching elements Q1 to Q9. However, a transistor, an IGBT, or the like may be used instead of the FET.

In each embodiment, the diodes D1 to D7 are used as the rectifying element of the secondary side. However, the FET may be used instead of the diode.

In each embodiment, the voltage converting device mounted in the vehicle is exemplified. However, one or more embodiments of the invention can also be applied to a voltage converting device other than the vehicle.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A voltage converting device provided between a DC power supply and a load, the voltage converting device comprising:
a first voltage converting circuit that converts a voltage of the DC power supply into a voltage of a predetermined level;
a second voltage converting circuit that converts the voltage of the DC power supply into a voltage of a predetermined level; and
a control unit that controls operations of the first voltage converting circuit and the second voltage converting circuit,
wherein the first voltage converting circuit and the second voltage converting circuit are connected in parallel,
wherein a rated output of the second voltage converting circuit is greater than a rated output of the first voltage converting circuit,
wherein under a condition where the load is a small load of which capacity is less than a fixed capacity, the control unit operates only the first voltage converting circuit and stops an operation of the second voltage converting circuit,
wherein under a condition where the load is a large load of which capacity is equal to or greater than the fixed capacity, the control unit operates both the first voltage converting circuit and the second voltage converting circuit, and
wherein in a process where the load is switched from the small load to the large load, the control unit stops the first voltage converting circuit and operates only the second voltage converting circuit, and then operates the first voltage converting circuit.

2. The voltage converting device according to claim 1,
wherein in a process where the load is switched from the small load to a medium load of which capacity is greater than that of the small load and is smaller than that of the large load, the control unit operates both the first voltage converting circuit and the second voltage converting circuit, and then stops the first voltage converting circuit.

3. A voltage converting device provided between a DC power supply and a load, the voltage converting device comprising:
a first voltage converting circuit that converts a voltage of the DC power supply into a voltage of a predetermined level;
a second voltage converting circuit that converts the voltage of the DC power supply into a voltage of a predetermined level; and
a control unit that controls operations of the first voltage converting circuit and the second voltage converting circuit,
wherein the first voltage converting circuit and the second voltage converting circuit are connected in parallel,
wherein a rated output of the second voltage converting circuit is greater than a rated output of the first voltage converting circuit,
wherein under a condition where the load is a small load of which capacity is less than a fixed capacity, the control unit operates only the first voltage converting circuit and stops an operation of the second voltage converting circuit,
wherein under a condition where the load is a large load of which capacity is equal to or greater than a fixed capacity, the control unit operates both the first voltage converting circuit and the second voltage converting circuit, and
wherein in a process where the load is switched from the large load to the small load, the control unit stops the first voltage converting circuit and operates only the second voltage converting circuit, and then stops the second voltage converting circuit and operates the first voltage converting circuit.

4. The voltage converting device according to claim 3,
wherein the first voltage converting circuit is an LLC type converter comprising:
a transformer;
two switching elements that are provided on a primary side of the transformer and are connected in series to the DC power supply;
a series circuit of a capacitor and an inductor connected between a connection point of the switching elements and a primary winding of the transformer; and
a rectifying element that is provided on a secondary side of the transformer.

5. The voltage converting device according to claim 3,
wherein the first voltage converting circuit is a flyback type converter comprising:
a transformer;
a switching element that is provided on the primary side of the transformer and is connected in series to the primary winding of the transformer; and
a rectifying element that is provided on a secondary side of the transformer.

6. The voltage converting device according to claim 3,
wherein the second voltage converting circuit is a full bridge converter comprising:
a transformer;
four switching elements that are provided on the primary side of the transformer and are bridge-connected between the DC power supply and the primary winding of the transformer; and
a rectifying element that is provided on the secondary side of the transformer.

7. The voltage converting device according to claim 3,
wherein the second voltage converting circuit is a half bridge converter comprising:
a transformer;
two switching elements that are provided on the primary side of the transformer and are connected in series to the DC power supply; and
a rectifying element that is provided on the secondary side of the transformer.
